(19) United States
(12) Patent Application Publication
(10) Pub. No.: US 2006/0108073 A1
(43) Pub. Date: May 25, 2006

(54) Laminating press

(75) Inventor: Alain Brunet, Dolbeau-Mistassini (CA)

Correspondence Address: OGILVY RENAULT LLP, 1981 MCGILL COLLEGE AVENUE, SUITE 1600, MONTREAL, QC, H3A2Y3, CA

(73) Assignee: Pinexel Inc.

(21) Appl. No.: 10/994,249

(22) Filed: Nov. 23, 2004

(51) Int. Cl. B32B 37/00; B30B 15/34

(52) U.S. Cl. 156/580; 156/583.1

(57) ABSTRACT

A laminating press comprises a plurality of press units adapted to individually receive respective stacks of individual laminae and press the laminae together face to face so as to independently form in parallel a corresponding number of laminated products. The press units are mounted along a conveyor and displaced thereby between a loading position and a discharged position while individually holding their respective stacks of laminae in compression.

### BACKGROUND OF THE INVENTION

1. Field of the Invention

The present invention relates generally to lamination processes and apparatuses and, more particularly, to a laminating press suited for making laminated beams.

2. Description of the Prior Art

A variety of laminated wood beams are used in construction work today as joists, girders, posts, columns or other structural pieces. Laminated wood beams are known to be stronger, more resistant and more dimensionally stable than continuous wood beams.

The laminated beams are made from stack of individual laminae coated with an adhesive and then maintained face to face in compression while the adhesive is allowed to set.

The prior art laminating presses used to maintain the stacks of laminae in compression are relatively complex, cumbersome and generally very costly to purchase.

### SUMMARY OF THE INVENTION

It is therefore an aim of the present invention to provide a new laminating press which is relatively simple and economical.

It is also an aim of the present invention to provide a laminating press which is of compact construction.

Therefore, in accordance with an aspect of the present invention, there is provided a laminating press comprising a frame, a conveyor mounted to said frame, and a plurality of press units adapted to individually receive respective stacks of individual laminae and press the laminae together face to face so as to independently form in parallel a corresponding number of laminated products, the press units being mounted along the conveyor and displaceable thereby between a loading position and a discharged position while individually holding their respective stacks of laminae in compression.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a perspective view of a beam-laminating press in accordance with an embodiment of the present invention;

FIG. 2 is a side elevation view of the beam-laminating press shown in FIG. 1;

FIG. 3 is an enlarged side view of an edge aligning system forming part of the beam-laminating press shown in FIG. 1;

FIG. 4 is a side view of a backstop mechanism forming part of the beam-laminating press shown in FIG. 1; and

FIGS. 5a and 5b are schematic side views of an automatic release system forming part of the beam-laminating press shown in FIG. 1.

### DESCRIPTION OF THE PREFERRED EMBODIMENTS

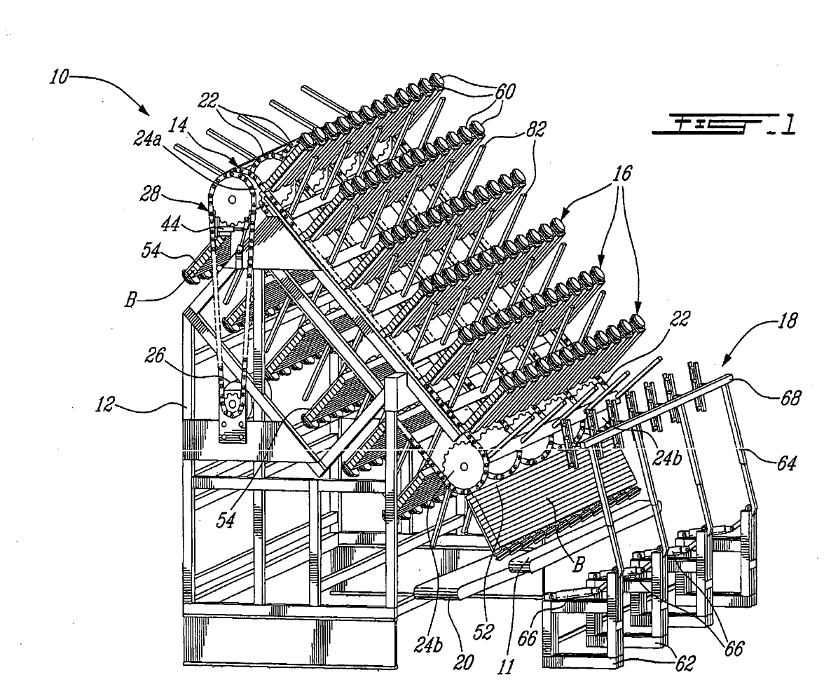

FIG. 1 illustrates an embodiment of a laminating press 10 suited for making laminated cross lumber beams or timbers B composed of a plurality of elongated wood pieces bonded together face to face.

The laminating press 10 generally comprises an infeed conveyor 11 for feeding the press 10 with individual laminae, for instance elongated wood planks, a frame 12 defining an inclined plane on which is mounted a hydraulic conveyor 14, a plurality of individual press units 16 (13 in the illustrated example) fixedly mounted at regular intervals along the conveyor 14 and driven thereby, an edge aligning system 18 mounted on a side of the infeed conveyor 11 opposite the frame 12, and a discharge conveyor 20 extending parallel to the infeed conveyor 11 underneath the lower end of the frame 12 for successively receiving laminated beams B from the individual press units 16. The inlet and discharge conveyors 11 and 20 are preferably provided in the form of endless belt conveyors and are of conventional construction.

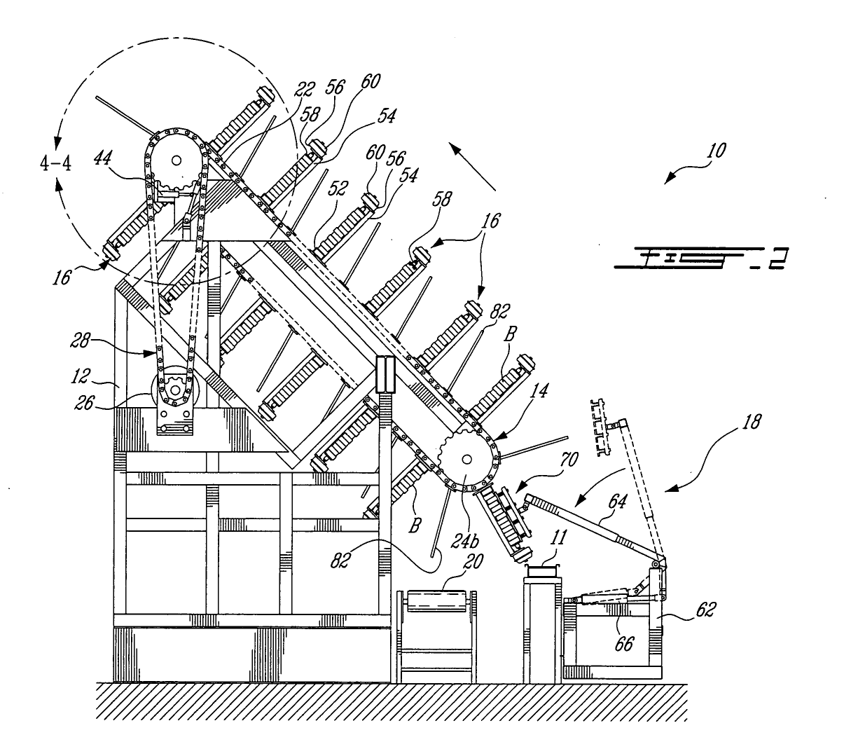

The frame 12 is made from heavy sturdy steel tubes assembled to each other such as by welding. The frame 12 is configured to support the hydraulic conveyor 14 carrying the press units 16 at an angle of about preferably 45 degrees while providing the required clearance for the passage of the press units 16 on the return run or bottom run of the conveyor 14 as shown in FIGS. 1 and 2. Mounting the conveyor 14 at an angle is advantageous in that it provides for significant space saving and, thus, important operating cost reductions

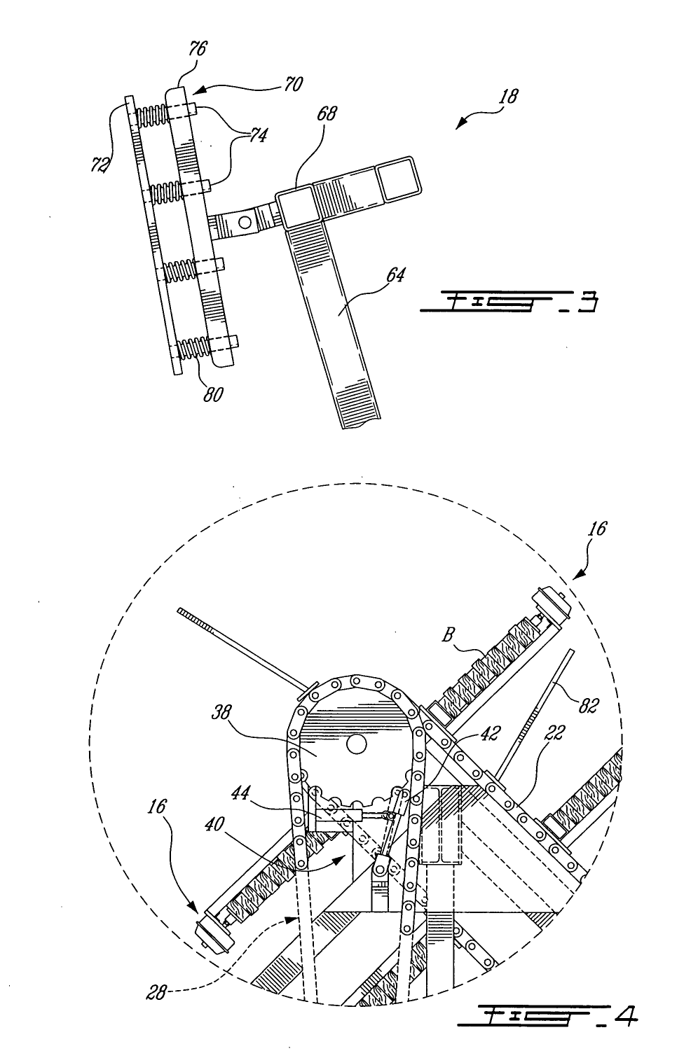

The hydraulic conveyor 14 comprises a plurality (five in the illustrated embodiments) of laterally spaced-apart endless chains 22 trained about pairs of longitudinally spaced-apart sprockets 24a and 24b. The top and bottom sprockets 24a and 24b are mounted to respective axles extending transversally at the top and bottom ends of the frame 12, respectively. At least one of the axles, preferably the one at the top end of the frame 12, is driven by a hydraulic motor 26 (FIG. 2) through a chain transmission 28 to drive the laterally spaced-apart endless chains 22 in unison in either one of a forward direction and a backward direction. As shown in FIG. 4, the chain transmission includes a sprocket wheel 38. A backstop mechanism 40 is selectively engageable with the sprocket wheel 38 to substantially eliminate the back loads on the hydraulic motor 26, thereby allowing using a smaller and less expensive motorization to drive the chains 22 and, thus, the press units 16. It also advantageously provides for the use of a bi-directional motor.

The backstop mechanism 40 includes a pawl 42 in the form of a small pivoted latch selectively engageable with the teeth of the sprocket wheel 38 to lock the same against clockwise rotation. As shown in FIG. 4, the pawl 42 is pivoted between an idle position and a locking position (shown in broken lines) by a small pneumatic or hydraulic cylinder 44. The pawl 42 is normally maintained in its idle position by cylinder 44.

As shown in FIGS. 1 and 2, each press section 16 includes a stationary jaw or platen 52, for instance in the form of an elongated rectangular tube member fixedly secured to the endless chains 22 of the conveyor 14 and extending transversally with respect thereto, a stack support preferably provided in the form of a number of upstanding backing members 54 extending at right angles from the stationary jaw 52 at regular intervals therealong to form a side arresting surface for the stack of laminae to be pressed bonded together, an elongated plate 56 extending parallel to the stationary jaw 52 to unitize the backing members 54 at the end thereof opposite to the stationary jaw 52, a movable jaw or platen comprising a number of movable jaw segments 58 operated by pairs of pneumatic actuators 60 mounted to the elongated plate 56. The pneumatic actuators 60 are preferably provided in the form of pneumatic dampers or chock absorbers of the type used in truck and tractor suspensions. The use of that type of fluid driven actuator is advantageous in that it provides for the application of a uniform pressure all along the length of the stack of laminae and prevents the wood from being damaged. The use of pneumatic actuators instead of hydraulic cylinders is also advantageous in that it permits to reduce the size of each press units, which results in savings in operating and maintenance costs. Each movable jaw segment 58 is displaceable toward and away from the stationary jaw 52 to press and release the stack of elongated laminae loaded in the press units 16. The movable jaw segments 58 permit to apply individual pressing load along the stack of elongated laminae, thereby allowing accommodating variations in the height of the stack along the length thereof. The application of punctual pressing loads provides added flexibility. The above-described press unit 16 is advantageous in that it provides for the lamination of beams of various thickness, width, length and type of wood without variations in the quality of the final product. However, it is understood the movable jaw segments 58 could be replaced by a continuous elongated jaw or platen. Also, the elongated plate 56 could be replaced by a number of plate segments pairing the baking members 54 and supporting a pair of pneumatic actuators 60.

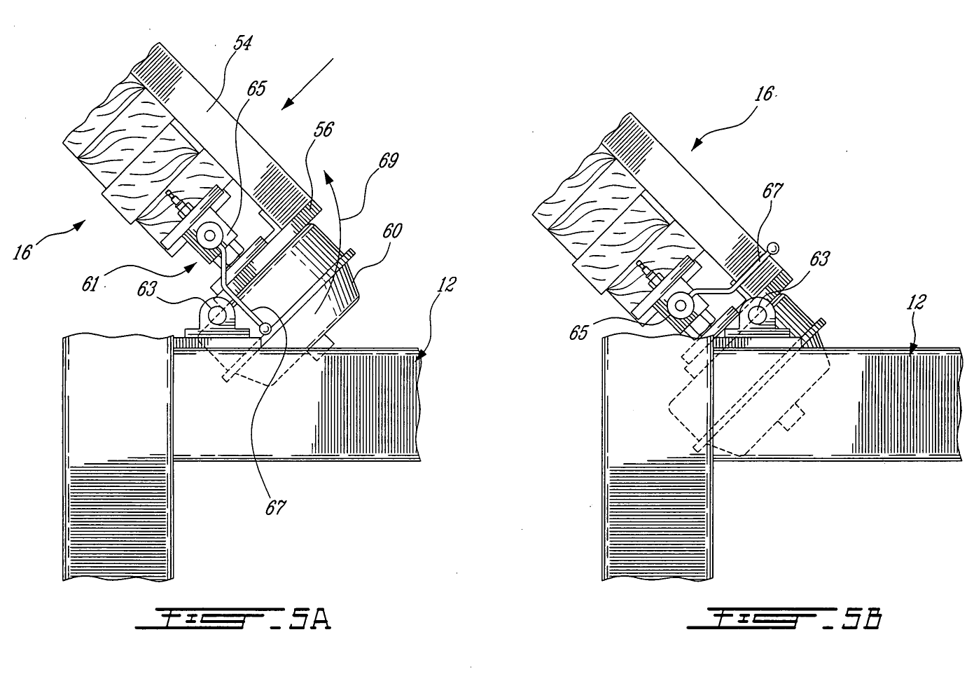

As shown in FIGS. 5a and 5b, each press unit 16 is further provided with an automatic pressure release system 61 to automatically release a stack of bonded laminae directly onto the discharge conveyor 20 each time a press unit 16 engages a triggering arm 63 fixed on one side of the lower end of the frame 12. More particularly, the system 61 comprises a valve 65 displaceable from a closed position (FIG. 5a) for maintaining the pressure within the pneumatic actuators 60 to an open position (FIG. 5b) for purging the fluid pressure from the actuators 60, thereby allowing the bonded laminae to drop by gravity onto the discharge conveyor 20. The valve 65 is displaced between the open and closed positions thereof by an actuating lever 67. As shown in FIGS. 5a and 5b, while the press unit 16 is driven forward by the conveyor 14, the lever 67 contacts the triggering arm 63 which causes the lever 67 to pivot in the direction indicated by arrow 69 to the position shown in FIG. 5b, thereby causing the pressure in the pneumatic actuators 60 to be released.

As best shown in FIGS. 2 and 3, the edge aligning system 18 comprises a frame 62, a number of laterally spaced-apart pivot arms 64 pivotally mounted to the frame 62 and operated by respective hydraulic cylinders 66 (four in the illustrated example) which are, in turn, pivotally mounted between the frame 62 and the pivot arms 64. The arms 64 are rigidly link together at their upper ends by a cross tubular member 68. A number of spring-loaded pressing members 70 are pivotally mounted at regular intervals along the cross tubular member 68. As shown in FIG. 3, each spring-loaded pressing member 70 comprises a pusher 72 mounted for sliding movement on a series of pins 74 extending at right angles from a base member 76. Springs 80 are mounted about the pins 74 between the base member 76 and the pusher 72. As shown in FIG. 2, the cylinders 66 are retracted to cause the pivot arms 64 to pivot from an idle position (shown in broken lines) to an operational position in which the pusher 72 are pressed against the side edges of the stack of laminae that has just been loaded in one of the press units 16. By so conjointly applying the pushers 72 against the side edges of the stack of laminae, the offsets between each of the laminae can be reduced before the laminae be pressed bonded together face to face by the pressing unit 16 in which the stack has been loaded. This system contributes to reduce wood fibre waste.

In operation, individual elongated laminae, such as elongated wood members, are fed lengthwise to the press 10 via the infeed conveyor 11. The hydraulic conveyor 14 is operated to position one of the press units 16 at a loading position at the bottom of the frame 12, as shown in FIGS. 1 and 2. Then, the conveyor 14 is stopped and pawl 42 is engaged with sprocket wheel 38 to prevent the transmission of backlash forces to the motor 26.

The press unit 16 to be loaded with a stack of laminae is preferably stopped at an angle to the infeed conveyor 11, as shown in FIG. 2. The individual laminae are then manually stacked into the press unit 16. It is understood that the opposed faces of the laminae are covered with an adhesive. It is also understood that depending on the length of the laminae, more than one stack could be placed end-to-end into a same press unit 16 in order to simultaneously form a corresponding number of laminated beams.

Once the individual laminae have been properly stacked into the press unit 16, the cylinders 66 of the edge-aligning system 18 are retracted to cause the pushers 72 to press the stack of laminae against the backing members 54 of the press unit 16 in order to appropriately align the laminae with respect to each other. While the stack of laminae is held at the sides thereof between the pushers 72 and the backing members 54, the pneumatic actuators 60 of the press unit 16 are connected by the operator to a source of pneumatic pressure to cause the mobile jaw segments 58 to move towards the fixed jaw 52, thereby pressing the laminae face to face. The pneumatic actuators 60 are pressurized to the desired pressure and then disconnected from the pneumatic source. Thereafter, the hydraulic cylinders 66 are expanded to cause the arms 64 to pivot back to their idle position (shown in broken lines in FIG. 2), thereby moving the pushers 72 away from the compressed stack of laminae held between the mobile jaw 58 and the fixed jaw 52 of the press unit 16.

The hydraulic conveyor 14 is then powered back to bring the next press unit 16 in position for receiving and compressing another stack of laminae as per the procedure described hereinabove. The press units 16 are, thus, sequentially loaded. While the press units 16 are carried about the loop defined by the conveyor 14, the mobile jaw segments 58 are maintained press against the stacks of laminae to cure the beams. During the setting period, the press units 16 are sequentially brought to an unloading position at the lower end of the return line of the conveyor 14 above the discharge conveyor 20. The press units 16 are sequentially unloaded each time a press unit 16 completes its run about the conveyor 14 and passes by the triggering arm 65. Once the actuating lever 67 of the valve 65 of the pneumatic actuators 60 of the press unit 16 passing by the triggering arm 63 has been rotated to its open position, as shown in FIG. 5b, the pressure exerted by the mobile jaw segments 58 on the laminated beam is released and the beam falls down by gravity onto the discharge conveyor 20. Guards 82 are preferably fixedly mounted on the endless chains 22 between each press unit 16 to ensure that the laminated beams fall onto the discharge conveyor 20 and not on a side thereof. The guards 82 are preferably provided in the form of upstanding tubular members slightly inclined to the vertical in a direction away from the press units 16 located immediately downstream thereof with respect to the direction of travel of the press units 16 (i.e. the counter clockwise direction in the embodiment illustrated in FIG. 1).

The above described press 10 is cheaper and simpler than conventional laminating press of equivalent capacity. Furthermore, it is of compact construction which results in important cost savings.

While a detailed description of an embodiment of the present invention has been given, it is understood that many changes and modifications may be made without departing from the spirit of the invention. All such modifications are intended to be included within the scope of the appended claims.

1. A laminating press comprising a frame, a conveyor mounted to said frame, and a plurality of press units adapted to individually receive respective stacks of individual laminae and press the laminae together face to face so as to independently form in parallel a corresponding number of laminated products, the press units being mounted along the conveyor and displaceable thereby between a loading position and a discharged position while individually holding their respective stacks of laminae in compression.

2. The laminating press according to claim 1, wherein said conveyor comprises at least one endless conveyor member driven by a motor, and wherein said press units are fixedly secured to said endless conveyor member at spaced-apart locations therealong.

3. The laminating press according to claim 2, wherein said conveyor is supported at an angle on said frame.

4. The laminating press according to claim 3, wherein the conveyor is inclined at an angle of about 45 degrees.

5. The laminating press according to claim 1, wherein each of said press units has a pair of clamping jaws relatively displaceable between open and closed positions, said clamping jaws extending lengthwise in a direction transversal to said conveyor.

6. The laminating press according to claim 5, wherein said conveyor includes at least one endless conveyor member driven by a motor, and wherein each pair of clamping jaws comprises a stationary jaw fixedly secured to said at least one endless conveyor member and a mobile jaw provided at a distal end of a support member extending from said stationary jaw away from said endless conveyor member to provide a support surface for the stack of laminae held between the pair of clamping jaws.

7. The laminating press according to claim 6, wherein said mobile jaw is operated by a plurality of pneumatic actuators mounted to said distal end of said support member and distributed in a direction transversal to said endless conveyor member along a length of said mobile jaw.

8. The laminating press according to claim 2, wherein a pawl is selectively engageable with a sprocket wheel connected between said motor and said endless conveyor member to prevent backward rotation of the sprocket wheel and back load transmission to the motor.

9. The laminating press according to claim 1, further including an infeed conveyor provided at one end of said conveyor on which the press units are mounted, and wherein said press units are successively brought adjacent to said infeed conveyor by said conveyor to said loading position thereof for allowing the press units to be loaded one after the other.

10. The laminating press according to claim 9, wherein the infeed conveyor is parallel to the press units and transversal to the conveyor carrying the press units, and wherein said conveyor is inclined relative to said infeed conveyor, the infeed conveyor being located adjacent to a lower end of the conveyor.

11. The laminating press according to claim 1, wherein each time one of said press units is advanced to said discharged position thereof, a release mechanism is triggered to automatically cause said one press unit to release the stack of laminae held thereby.

12. The laminating press according to claim 11, wherein each of said press units comprises a mobile jaw operated by at least one fluid driven actuator, and wherein said release mechanism comprises a valve operatively connected to said at least one fluid driven actuator, the valve being operated by an actuating lever, and wherein said actuating lever is disposed to be moved as a result of an engagement with a triggering arm fixed to the frame just upstream of said discharged position of said press units.

13. The laminating press according to claim 11, wherein the stacks of laminae successively released by said press units at said discharged position thereof fall by gravity onto a discharge conveyor.

14. The laminating press according to claim 1, wherein while one of said press units is immobilized at said loading position thereof, an edge aligning system is operated to align the side edges of the laminae in the stack loaded in said one press unit, said edge aligning system comprising at least one actuator operating at least one arm carrying a spring-loaded pusher.

15. The laminating press according to claim 14, wherein said spring loaded pusher is pivotally connected to said at least one arm.

16. The laminating press according to claim 15, wherein said at least one arm is pivotable between an idle position and an operational position by said at least one actuator, said at least one actuator including a fluid driven actuator.

17. The laminating press according to claim 13, wherein a guard extends from the conveyor between each pair of adjacent press units to prevent the stacks of laminae from falling outwardly of the discharge conveyor when dropped from the press units.
